(19) United States
(12) Patent Application Publication
(10) Pub. No.: US 2025/0199868 A1
(43) Pub. Date: Jun. 19, 2025

(54) SECURE MULTI-TENANCY FOR EDGE ENVIRONMENTS

(71) Applicant: DELL PRODUCTS L.P., Round Rock, TX (US)

(72) Inventors: Parminder Singh Sethi, Punjab (IN); Srinath Kappgal, Cork (IE); Daniel L. Hamlin, Round Rock, TX (US); Malathi Ramakrishnan, Madurai (IN); Praveen Kumar, Noida (IN)

(73) Assignee: DELL PRODUCTS L.P., Round Rock, TX (US)

(21) Appl. No.: 18/537,941

(22) Filed: Dec. 13, 2023

(51) Int. Cl. G06F 9/50; H04L 9/40

(52) U.S. Cl. CPC G06F 9/5038; H04L 63/0428

(57) ABSTRACT

In a system for providing secure multi-tenancy including a plurality of edge nodes, and each edge node may receive, from a central management system, resource isolation instructions associated with a first tenant and a second tenant. In response, the edge node may allocate a first set of resources to the first tenant, and a second set of resources to the second tenant. The edge node may then process data associated with the first and second tenants using the assigned sets of resources.

### TECHNICAL FIELD

The present disclosure relates in general to information handling systems, and more particularly to techniques for management of information handling systems.

### BACKGROUND OF THE INVENTION

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware® vSphere® ESXi™ environment, or any other HCI management system). Some examples of HCI systems may operate as software-defined storage (SDS) cluster systems (e.g., an SDS cluster system such as the VMware® vSANT™ system, or any other SDS cluster system).

In the HCI context (as well as other contexts), information handling systems may execute virtual machines (VMs) for various purposes. A VM may generally comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

In many HCI implementations, an administrator may use a centralized management system (e.g., a cloud-based system, or in general any information handling system communicatively coupled to the HCI nodes via a network). The centralized management system may communicate with HCI nodes individually to perform various management tasks such as provisioning, monitoring, upgrading, etc.

It should be noted that the discussion of a technique in the Background section of this disclosure does not constitute an admission of prior-art status. No such admissions are made herein, unless clearly and unambiguously identified as such.

### SUMMARY OF THE INVENTION

In accordance with the teachings of the present disclosure, the disadvantages and problems associated with management of information handling systems may be reduced or eliminated.

In accordance with embodiments of the present disclosure, a system for providing secure multi-tenancy may include a plurality of edge nodes, each edge node including at least one processor and a memory and being in communication with at least one other edge node via a communications network. Each edge node may be configured to perform operations including receiving, from a central management system via the communications network, resource isolation instructions associated with a first tenant; in response to receiving the resource isolation instructions associated with the first tenant, allocating a first set of resources to the first tenant; receiving, from the central management system, resource isolation instructions associated with a second tenant different than the first tenant; in response to receiving the resource isolation instructions associated with the second tenant, allocating a second set of resources to the second tenant, wherein the first set of resources and the second set of resources are distinct; processing data associated with the first tenant using the first set of resources; and processing data associated with the second tenant using the second set of resources.

In some cases, the operations performed by each edge node further include: receiving, from the central management system, access control instructions associated with the first tenant; and in response, controlling access by the first tenant to data associated with the edge node based on the access control instructions.

In some cases, controlling access to data includes preventing the first tenant from accessing data not associated with the first tenant.

In some implementations, controlling access to data includes encrypting data associated with the first tenant using credentials exclusive to the first tenant.

In some cases, encrypting data includes encrypting data stored in the memory of the edge node.

In some implementations, encrypting data includes encrypting data prior to transmission of the data by the edge node via the communications network.

In some implementations, controlling access to data is performed in accordance with a set of compliance requirements.

In accordance with embodiments of the present disclosure, a method for providing secure multi-tenancy in a system including a plurality of edge nodes, each edge node including at least one processor and a memory and being in communication with at least one other edge node via a communications network, includes: receiving, by an edge node of the plurality of edge nodes from a central management system via the communications network, resource isolation instructions associated with a first tenant; in response to receiving the resource isolation instructions associated with the first tenant, allocating, by the edge node, a first set of resources to the first tenant; receiving, by the edge node from the central management system, resource isolation instructions associated with a second tenant different than the first tenant; in response to receiving the resource isolation instructions associated with the second tenant, allocating, by the edge node, a second set of resources to the second tenant, wherein the first set of resources and the second set of resources are distinct; processing, by the edge node, data associated with the first tenant using the first set of resources; processing, by the edge node, data associated with the second tenant using the second set of resources.

In accordance with embodiments of the present disclosure, an article of manufacture includes a non-transitory, computer-readable medium having computer-executable instructions thereon that are executable by a processor of an edge node of an information handling system including a plurality of edge nodes for: receiving, by the edge node from a central management system via a communications network, resource isolation instructions associated with a first tenant; in response to receiving the resource isolation instructions associated with the first tenant, allocating, by the edge node, a first set of resources to the first tenant; receiving, by the edge node from the central management system, resource isolation instructions associated with a second tenant different than the first tenant; in response to receiving the resource isolation instructions associated with the second tenant, allocating, by the edge node, a second set of resources to the second tenant, wherein the first set of resources and the second set of resources are distinct; processing, by the edge node, data associated with the first tenant using the first set of resources; processing, by the edge node, data associated with the second tenant using the second set of resources.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE SEVERAL VIEWS OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a block diagram of an example of an information handling system, in accordance with embodiments of the present disclosure; and

FIG. 3 illustrates a block diagram of another example of an information handling system, in accordance with embodiments of the present disclosure.

### DETAILED DESCRIPTION OF THE INVENTION

Existing edge environments generally lack a robust framework for secure multi-tenancy, which leads to challenges in sharing resources among multiple tenants while maintaining security. For example, inadequate resource isolation in such environments may allow for potential unauthorized access or interference with tenants' resources. In addition, insufficient data privacy measures may increase the risk of unauthorized disclosure of sensitive information. Inefficient resource utilization may hamper performance and result in wastage of shared resources. The absence of controlled access mechanisms may enable unauthorized access to resources, jeopardizing the security of the multi-tenant environment. Without strong encryption techniques, data in transit and at rest within the edge environment may be susceptible to unauthorized access and breaches. Lack of a comprehensive resource monitoring system may prevent effective management of resource allocation, usage, and performance, leading to inefficiencies. Insufficient threat detection mechanisms may increase the vulnerability of the multi-tenant environment to security breaches. The absence of streamlined processes for tenant onboarding/offboarding may result in challenges when provisioning and deprovisioning resources. Failure to address industry-specific regulations and compliance requirements can lead to legal issues and non-compliance.

The present disclosure describes a robust framework for secure multi-tenancy in edge environments that addresses these and other issues with existing edge environments. The framework described herein provides several advantages, such as those described below.

Secure Multi-Tenancy: The framework provides a comprehensive solution for enabling secure sharing of resources among multiple tenants in edge environments. It combines various security measures and mechanisms to ensure isolation, controlled access, and data privacy.

Efficient Resource Utilization: The framework promotes efficient resource utilization by optimizing the allocation and usage of shared resources. It aims to minimize wastage and maximize performance, resulting in improved overall system efficiency.

Comprehensive Security Measures: The framework incorporates robust security measures, including resource isolation, access control, encryption, threat detection, and compliance adherence. These measures work together to mitigate risks and prevent unauthorized access or data breaches.

Edge Environment Focus: The framework specifically targets edge environments, where resource constraints and distributed architecture pose unique challenges. By tailoring the solution to edge environments, it addresses the specific requirements and constraints of these environments, ensuring optimal performance and security.

Streamlined Tenant Onboarding/Offboarding: The framework establishes streamlined processes for provisioning and deprovisioning resources for tenants. This simplifies the onboarding and offboarding of tenants, ensuring smooth operations and minimizing security risks associated with tenant transitions.

Industry-specific Compliance: The framework addresses industry-specific regulations and compliance requirements, ensuring adherence to legal standards. This is particularly important in sectors such as healthcare or finance, where data privacy and regulatory compliance are critical.

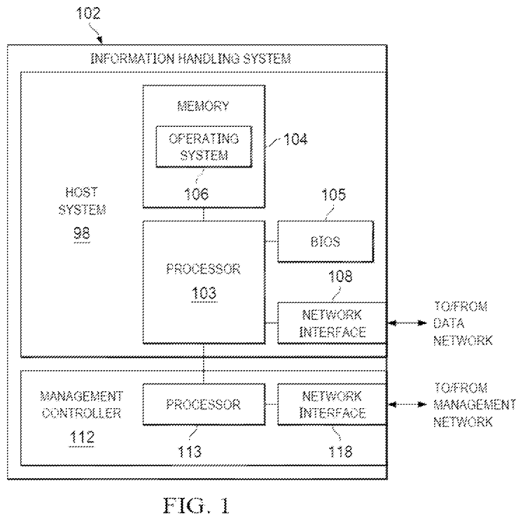

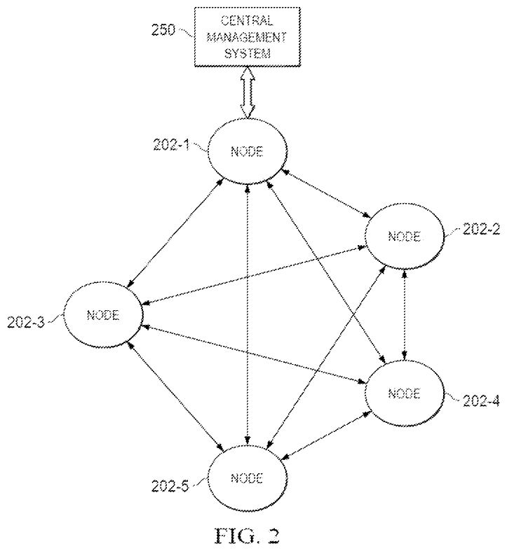

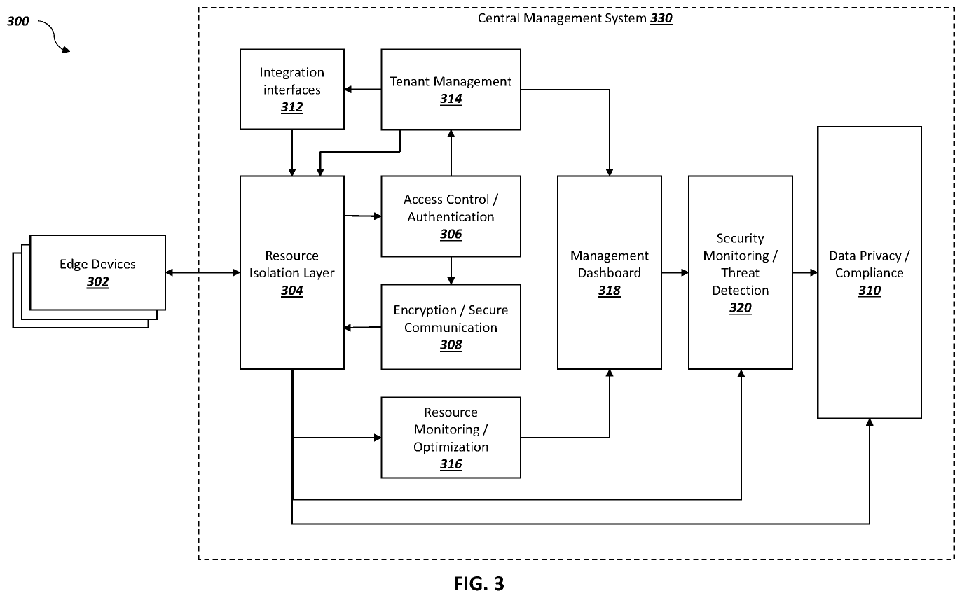

Preferred embodiments and their advantages are best understood by reference to the FIGURES, wherein like numbers are used to indicate like and corresponding parts. FIGS. 1 and 2 and the associated descriptions below describe generic features of an information handling system. FIG. 3 and its associated description describe features of the information handling system related to providing secure multi-tenancy.

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure provide improvements in management of information handling systems 102 (e.g., edge nodes). It should be noted that while the scenario of an edge deployment is discussed in detail herein for the sake of concreteness, other embodiments are also specifically contemplated within the scope of this disclosure.

In particular, embodiments may employ distributed autonomous edge nodes to assist the centralized management system in performing its management tasks. The centralized management system may communicate with a subset of the edge nodes (e.g., one or more of the edge nodes at each edge deployment) instead of communicating directly with every edge node. Members of this subset may then autonomously communicate with their “neighbors” (e.g., other systems within the same edge deployment) to carry out the management tasks.

By performing status checks and/or distributing management instructions (e.g., configuration changes, updates, etc.) with their neighbors autonomously, the subset of the edge nodes may synchronize configurations across the whole edge deployment and/or the whole HCI system without the need for the centralized management system to communicate directly with every edge node.

In one embodiment, the specific number of neighbors that should be managed by a given edge node in the subset can be calculated by a mathematic model to fit the system's design requirements. In other embodiments, the number of neighbors managed by a given edge node in the subset may be hard-coded or provided as a variable that an administrator may set.

Embodiments may thus provide distributed system management for a large number of edge computing systems. Health checks may be carried out by neighbors in one or more large edge deployments, avoiding the necessity for each edge node to be checked directly by the centralized management system. Configuration changes and updates may also be synchronized between neighbors in large edge deployments, avoiding the necessity for such changes to be provided directly by the centralized management system.

Turning now to FIG. 2, an example architecture is shown for autonomous management of information handling systems. As shown, edge nodes 202-1 through 202-5 (collectively, nodes 202) are communicatively coupled to one another (e.g., via a local edge deployment network). They may also be communicatively coupled to central management system 250 (e.g., via the internet).

In one embodiment, central management system 250 may communicate directly with node 202-1 to perform monitoring and management tasks. The other nodes 202 may communicate (directly or indirectly) with node 202-1, which may act as a portal for status and management information. For example, the other nodes may transmit status information to node 202-1, which may aggregate the information and pass it along to central management system 250. Updates and other management instructions may likewise be sent from central management system 250 to node 202-1, which may distribute them to the other nodes 202.

The communication between node 202-1 and the other nodes 202 may be either direct or indirect. For example, node 202-4 may communicate directly with node 202-1, or it may communicate with node 202-2, which may pass information along to node 202-1.

In one embodiment, each communication may include a time stamp associated therewith to indicate the time of origination. In this way, nodes 202 may determine the order in which instructions were issued, such that later instructions may supersede earlier instructions, etc. Time stamps may further be employed to reduce unnecessary duplication of communications. For example, if one node has broadcast a message to its neighbor nodes, and one of those nodes has already transmitted the message to central management system 250 at a particular time, then the other nodes need not retransmit the message at a later time.

In one embodiment, the arrangement of FIG. 2 may allow neighbors to perform health checks autonomously on one another in the event that communication is lost between central management system 250 and nodes 202. For example, if communication is interrupted between central management system 250 and node 202-1, then central management system 250 may contact node 202-5 and instruct it to perform the functionality previously handled by node 202-1. For example, node 202-5 may then perform health checks, heartbeat monitoring, and other tasks with regard to itself and the other nodes 202, reporting the results to central management system 250.

In one embodiment, this may be triggered based on a lack of communications between node 202-1 and central management system 250 that lasts more than a threshold amount of time. The threshold may be calculated based on a mathematic model that takes into account the characteristics of the node deployment. In other embodiments, the threshold may be hard-coded or provided as a variable that an administrator may set. In one implementation, the communication frequency and timing may incorporate a random or pseudorandom element, such that communications are staggered to avoid overwhelming the network infrastructure.

Turning now to FIG. 3, another example architecture is shown for providing secure multi-tenancy in an information handling system 300 including edge devices. As shown, the system 300 includes one or more edge device 302 communicatively coupled to central management system 330. In some cases, the edge devices 302 may include the functionality of the nodes 202-1 through 202-5 described above, and the central management system 330 may include the functionality of central management system 250 described above.

Edge devices 302 are physical devices, such as edge servers or Internet-of-Things (IoT) devices, that are located at the network edge. The edge devices 302 collect and process data from the edge environment, and serve as the entry point into the information handling system 300 for tenants' applications.

The resource isolation layer 304 ensures the secure isolation of resources for each tenant. In some cases, the resource isolation layer 304 utilizes mechanisms like virtualization or containerization to create separate runtime environments on the edge devices 302, preventing unauthorized access or interference between tenants. In some cases, the resource isolation layer communicates commands to the edge devices 302 (such as through the integration interfaces 312, discussed below) in order to create the separate runtime environments on the various edge devices.

The access control and authentication component 306 manages tenant authentication and authorization. It enforces access control policies to ensure that each tenant can only access their authorized resources, maintaining the security of the multi-tenant environment. In some cases, the access control and authentication component 306 coordinates with the encryption and secure communication component 308 (described below) in order to ensure that data associated with one tenant is encrypted using credentials associated with that tenant, thereby ensuring that only that tenant can access and decrypt the data.

The encryption and secure communication component 308 handles the encryption and decryption of data in transit to and from the edge devices 302, and at rest (i.e., when the data is stored in the memory of the edge devices 302 or in other storage). The encryption and secure communication component 308 ensures that all communication between the edge devices 302, resource isolation layer 304, and tenant applications executed by the edge devices 302 is secured, protecting data from unauthorized access or interception.

The tenant management and provisioning component 314 handles tenant onboarding, offboarding, and resource provisioning. It includes processes and interfaces for creating and managing tenant accounts, allocating resources, and managing tenant-specific configurations.

The security monitoring and threat detection component 320 actively monitors the system for potential security threats and breaches. It utilizes techniques like intrusion detection systems, firewalls, and log analysis to detect and prevent security incidents, ensuring the overall security of the multi-tenant environment.

The data privacy and compliance component 310 ensures compliance with industry-specific regulations and data privacy requirements. It includes mechanisms for data anonymization, data retention policies, and auditing to protect sensitive information and demonstrate adherence to legal standards. In some cases, the data privacy and compliance component 310 may interact with and receive data from the access control and authentication component 306 and the encryption and secure communication component 308 regarding the state of data in the system 300, and may produce compliance reports or other output based on this data.

The resource monitoring and optimization component 316 monitors resource utilization, performance metrics, and capacity planning. It provides insights into resource usage to optimize allocation, identify bottlenecks, and ensure efficient utilization of shared resources.

The management dashboard component 318 provides a centralized interface for administrators to monitor and manage the secure multi-tenancy framework. It offers real-time visibility into system status, tenant performance, security alerts, and resource utilization, facilitating effective management of the system.

The integration interfaces 312 enable seamless integration with existing infrastructure components, such as edge computing platforms, network devices, and security systems. They promote interoperability and allow the framework to leverage existing technologies, enhancing its efficiency and effectiveness. In some cases, the integration interfaces 312 may implement various control protocols associated with different edge devices 302, allowing the centralized management system 330 to communicate with specific ones of the edge devices 302 that only respond to particular protocols. This enables the centralized management system 330 to interoperate with and control diverse edge devices 302, such as those manufactured by companies, including different hardware, executing different software (e.g., operating systems, virtualization environments, etc.), and the like.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. A system for providing secure multi-tenancy comprising:
a plurality of edge nodes, each edge node including at least one processor and a memory and being in communication with at least one other edge node via a communications network, wherein each edge node is configured to perform operations including:
receiving, from a central management system via the communications network, resource isolation instructions associated with a first tenant;
in response to receiving the resource isolation instructions associated with the first tenant, allocating a first set of resources to the first tenant;
receiving, from the central management system, resource isolation instructions associated with a second tenant different than the first tenant;
in response to receiving the resource isolation instructions associated with the second tenant, allocating a second set of resources to the second tenant, wherein the first set of resources and the second set of resources are distinct;
processing data associated with the first tenant using the first set of resources;
processing data associated with the second tenant using the second set of resources.

2. The system of claim 1, the operations performed by each edge node further including:
receiving, from the central management system, access control instructions associated with the first tenant;
in response to receiving the access control instructions associated with the first tenant, controlling access by the first tenant to data associated with the edge node based on the access control instructions.

3. The system of claim 2, wherein controlling access to data includes preventing the first tenant from accessing data not associated with the first tenant.

4. The system of claim 2, wherein controlling access to data includes encrypting data associated with the first tenant using credentials exclusive to the first tenant.

5. The system of claim 4, wherein encrypting data includes encrypting data stored in the memory of the edge node.

6. The system of claim 4, wherein encrypting data includes encrypting data prior to transmission of the data by the edge node via the communications network.

7. The system of claim 2, wherein controlling access to data is performed in accordance with a set of compliance requirements.

8. A method for providing secure multi-tenancy in a system including a plurality of edge nodes, each edge node including at least one processor and a memory and being in communication with at least one other edge node via a communications network, the method comprising:
receiving, by an edge node of the plurality of edge nodes from a central management system via the communications network, resource isolation instructions associated with a first tenant;
in response to receiving the resource isolation instructions associated with the first tenant, allocating, by the edge node, a first set of resources to the first tenant;
receiving, by the edge node from the central management system, resource isolation instructions associated with a second tenant different than the first tenant;
in response to receiving the resource isolation instructions associated with the second tenant, allocating, by the edge node, a second set of resources to the second tenant, wherein the first set of resources and the second set of resources are distinct;
processing, by the edge node, data associated with the first tenant using the first set of resources;
processing, by the edge node, data associated with the second tenant using the second set of resources.

9. The method of claim 8, further comprising:
receiving, by the edge node from the central management system, access control instructions associated with the first tenant;
in response to receiving the access control instructions associated with the first tenant, controlling, by the edge node, access by the first tenant to data associated with the edge node based on the access control instructions.

10. The method of claim 9, wherein controlling access to data includes preventing the first tenant from accessing data not associated with the first tenant.

11. The method of claim 9, wherein controlling access to data includes encrypting data associated with the first tenant using credentials exclusive to the first tenant.

12. The method of claim 11, wherein encrypting data includes encrypting data stored in the memory of the edge node.

13. The method of claim 11, wherein encrypting data includes encrypting data prior to transmission of the data by the edge node via the communications network.

14. The method of claim 9, wherein controlling access to data is performed in accordance with a set of compliance requirements.

15. An article of manufacture comprising a non-transitory, computer-readable medium having computer-executable instructions thereon that are executable by a processor of an edge node of an information handling system including a plurality of edge nodes for:
receiving, by the edge node from a central management system via a communications network, resource isolation instructions associated with a first tenant;
in response to receiving the resource isolation instructions associated with the first tenant, allocating, by the edge node, a first set of resources to the first tenant;
receiving, by the edge node from the central management system, resource isolation instructions associated with a second tenant different than the first tenant;
in response to receiving the resource isolation instructions associated with the second tenant, allocating, by the edge node, a second set of resources to the second tenant, wherein the first set of resources and the second set of resources are distinct;
processing, by the edge node, data associated with the first tenant using the first set of resources;
processing, by the edge node, data associated with the second tenant using the second set of resources.

16. The article of claim 15, wherein the computer-readable medium has further instructions thereon that are executable by the processor for:
receiving, by the edge node from the central management system, access control instructions associated with the first tenant;
in response to receiving the access control instructions associated with the first tenant, controlling, by the edge node, access by the first tenant to data associated with the edge node based on the access control instructions.

17. The article of claim 16, wherein controlling access to data includes preventing the first tenant from accessing data not associated with the first tenant.

18. The article of claim 16, wherein controlling access to data includes encrypting data associated with the first tenant using credentials exclusive to the first tenant.

19. The article of claim 18, wherein encrypting data includes encrypting data stored in the memory of the edge node.

20. The article of claim 18, wherein encrypting data includes encrypting data prior to transmission of the data by the edge node via the communications network.
